(19) United States
(12) Patent Application Publication
(10) Pub. No.: US 2007/0193527 A1
(43) Pub. Date: Aug. 23, 2007

(54) Ventilated animal cage assembly

(76) Inventors: Richard Verhage, Midland Park, NJ (US); Henry Verhage, Midland Park, NJ (US); Glenn Verhage, Midland Park, NJ (US)

Correspondence Address: SOFER & HAROUN LLP., 317 MADISON AVENUE, SUITE 910, NEW YORK, NY, 10017, US

(21) Appl. No.: 11/542,626

(22) Filed: Oct. 3, 2006

Related U.S. Application Data
(60) Provisional application No. 60/723,262, filed on Oct. 3, 2005.

(51) Int. Cl. A01K 1/03

(52) U.S. Cl. 119/418

(57) ABSTRACT

A ventilated rack system includes a frame having a plurality of cage bays, each for supporting an animal cage. At least two first and second vertical ventilation input ducts are disposed, one on either side of the frame. At least one air input cross-frame channel connects the first vertical ventilation input duct on one side of the frame to the second vertical ventilation input duct on the opposite side of the frame, where the air input cross-frame channel is configured to dispense ventilation air into the cages in the plurality of cage bays.

### RELATED APPLICATION

This application is related to and claims the benefit of priority from U.S. Provisional Patent Application No. 60/723,262, filed on Oct. 3, 2005, the entirety of which is incorporated herein by reference.

### FIELD OF THE INVENTION

The present invention relates to animal cages. More particularly, the present invention relates to multiple ventilated animal cage racks.

### BACKGROUND OF THE INVENTION

In the field of commercial application animal cages there are a number of existing arrangements for maintaining numerous animal cages within a single ventilated rack system. For example, larger testing projects at commercial and higher learning institutions may require upwards of hundreds of manageable habitats for maintaining the animals required. A typical arrangement may require the maintaining of several hundred lab mice, requiring a hundred or more separate cages.

As such, multi-cage ventilated rack systems have been developed for easier management of the animals. These racks typically hold about 40-50cages and maintain some form of ventilation. The cages are stored in the rack, but are removable for cleaning, feeding and for removing or inserting the animals.

Housing animals in close proximity with poor ventilation creates a number of potential issues, including increased risk of infection, spread of disease, transfer of viruses and bacteria, odors, rapid temperature fluctuation, uneven airflow, and poor overall hygiene. These problems can affect not only animal health and well being, but also the reliability and predictability of data furnished through scientific experiments and testing done on the animals. Ventilated cage racks are able to improve the cleaning interval for each cage from 4 to 7 days up to 14 days, by drying out the bedding and keeping ammonia levels lower.

However, even with these improvements, due to the inherent nature of animal storage, there are many problems that arise regarding cleaning of the cages, inadequate ventilation, unwanted cross-contamination, cage durability, ease of use etc . . . .

### OBJECTS AND SUMMARY

The present invention looks to overcome the drawbacks associated with the prior art, and to improve upon: the process for ventilating a number of animal cages in close proximity to each other; the efficiency of storing animals and their containers; the effectiveness of seals between the animal cage system and external vents; and the safeguards that reduce the transfer of contaminants from inside the cages to the external air supply. The invention also allows for better regulation of climate control within the animal cages and better overall animal health.

To this end, the present invention provides for a ventilated rack system includes a frame having a plurality of cage bays, each for supporting an animal cage. At least two first and second vertical ventilation input ducts are disposed, one on either side of the frame. At least one air input cross-frame channel connects the first vertical ventilation input duct on one side of the frame to the second vertical ventilation input duct on the opposite side of the frame, where the air input cross-frame channel is configured to dispense ventilation air into the cages in the plurality of cage bays.

### BRIEF DESCRIPTION OF THE DRAWINGS

The present invention can be best understood through the following description and accompanying drawings, wherein:

FIG. 1 illustrates a perspective view of an animal cage in accordance with one embodiment of the present invention;

FIG. 2 illustrates an exploded view of the animal cage from FIG. 1, in accordance with one embodiment of the present invention;

FIG. 3 illustrates a close up view of a grommet from FIGS. 1 and 2, in accordance with one embodiment of the present invention;

FIG. 4 illustrates a perspective view of the animal cage of FIG. 1 with a fitting for attachment to an automatic watering system, in accordance with another embodiment of the present invention;

FIG. 5 shows a cross section of a water bottle from the animal cage of FIG. 1, in accordance with one embodiment of the present invention;

FIG. 6, shows a close up of a lid latch for the animal cage of FIG. 1, in accordance with one embodiment of the present invention;

FIG. 7a illustrates a front perspective view of a ventilated rack system utilizing cages as shown in FIG. 1, in accordance with one embodiment of the present invention;

FIG. 7b illustrates a rear perspective view of the ventilated rack system from FIG. 7a, in accordance with one embodiment of the present invention;

FIG. 8 illustrates a close up view of a portion of cage lip from FIG. 1, in a cage bay of the rack system in FIGS. 7, in accordance with one embodiment of the present invention;

FIG. 9, illustrates a close up view perspective view of two cages in the ventilated rack system from FIGS. 7, in accordance with one embodiment of the present invention;

FIG. 10, illustrates a close cross section of two cages in the ventilated rack system from FIGS. 7, in accordance with one embodiment of the present invention;

FIG. 11, shows a cross section of four cages in a double sided ventilated rack system from FIGS. 7, in accordance with one embodiment of the present invention;

FIG. 12 illustrates the underside of an air exhaust cross-frame channel from ventilated rack system from FIGS. 7, in accordance with one embodiment of the present invention;

FIG. 13a illustrates a lid gasket in a first arrangement against an exhaust cross-frame channel, in accordance with one embodiment of the present invention; and

FIG. 13b illustrates a lid gasket in a second arrangement against an exhaust cross-frame channel, in accordance with one embodiment of the present invention.

### DESCRIPTION OF THE PREFERRED EMBODIMENTS

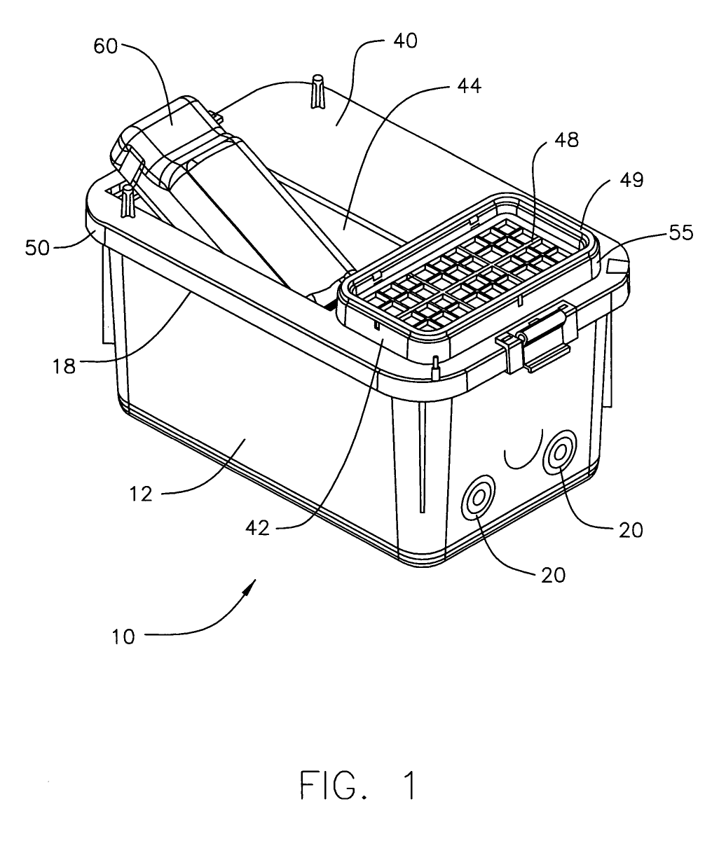

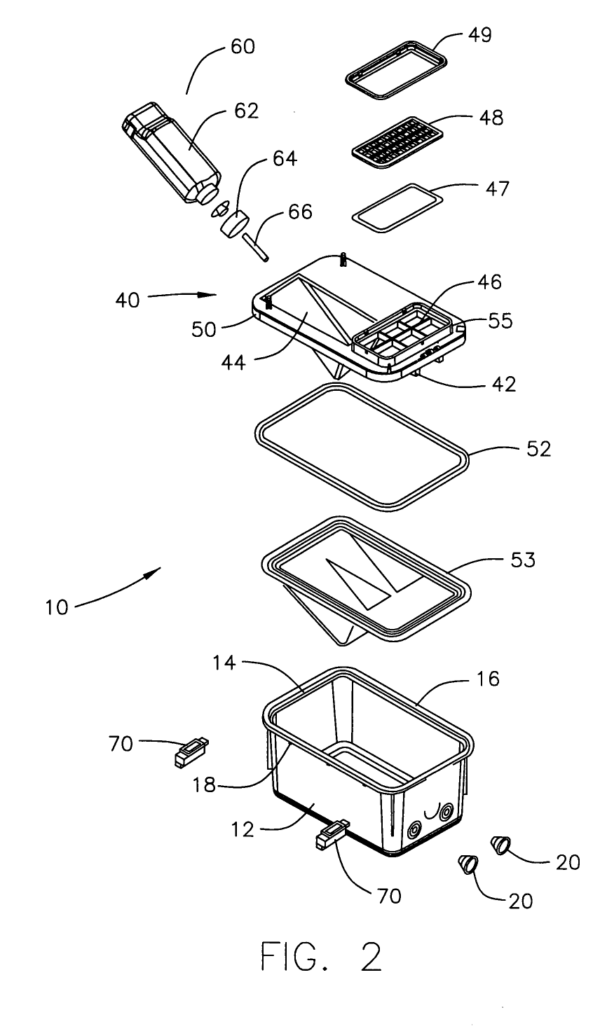

In one embodiment of the present invention, as illustrated in FIGS. 1 and 2, an animal cage 10 is shown, formed from a container base 12, a lid 40 and a water unit 60.

Beginning with container base 12, this portion is the principal housing for the animals. Typically, animal bedding is placed on the bottom and other such items including food dishes and animal toys. Base 12 is preferably constructed of a high durability polymer that can withstand prolonged use and frequent cleanings (e.g. autoclave), such as polycarbonate, polysulfone or polyetherimide, however the invention is not limited in this respect. Any polymer which is sufficiently durable for sustained use and cleaning may be used for base 12 in conjunction with the present invention.

As shown in FIG. 2, base 12 has a circumferential lip 14 that extends perpendicularly away from the top of the side walls and an upward flange 16, together configured to receive the connecting portions of lid 40.

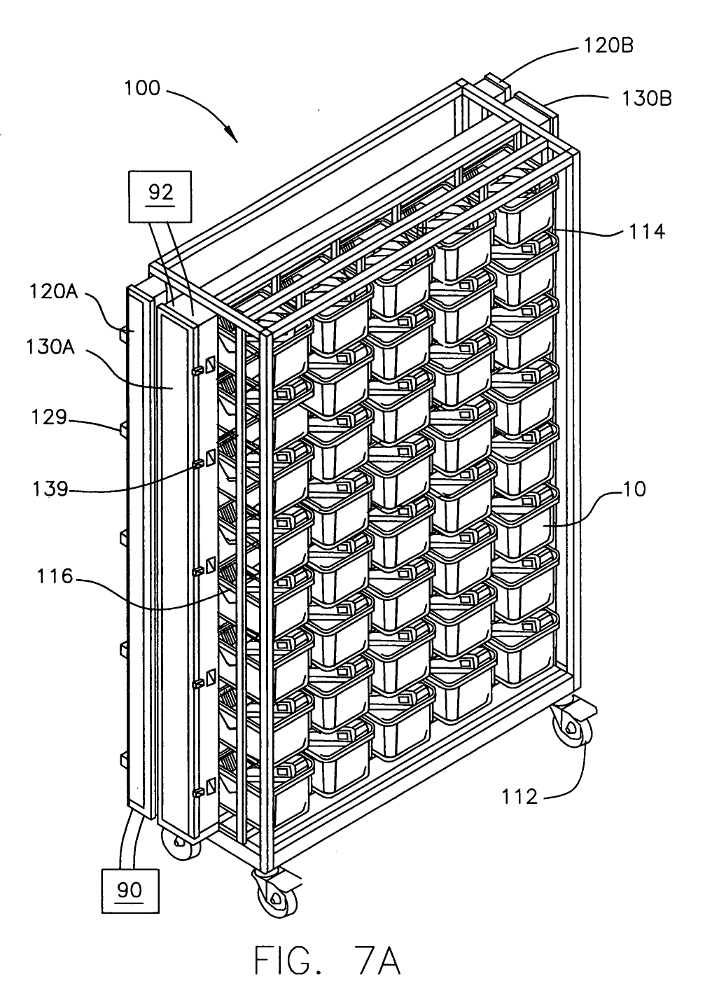

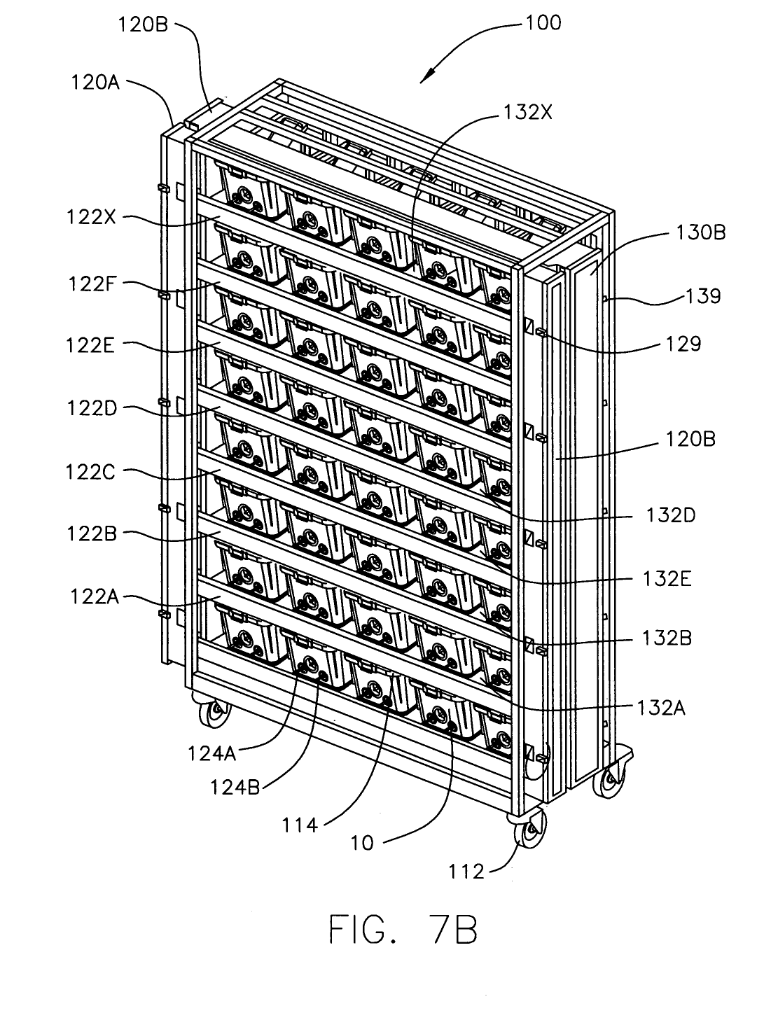

Furthermore, the underside of lip 14 is such that it allows base 12 to rest in a cage bay 114 in a ventilated rack system 100, as discussed in more detail below (see FIGS. 7a and 7b). Towards the front of base 12 a small angle latch 18 is disposed on the underside of lip 14 configured to lock cage 10 in place in bay 114, also discussed in more detail below.

The rear wall of base 12, near the bottom, maintains two air distribution grommets 20. It is understood that the present example shows two, but more than two may be used if desired. Grommets 20 are configured to act as interfaces between the ventilation inputs of rack system 100 and cage 10.

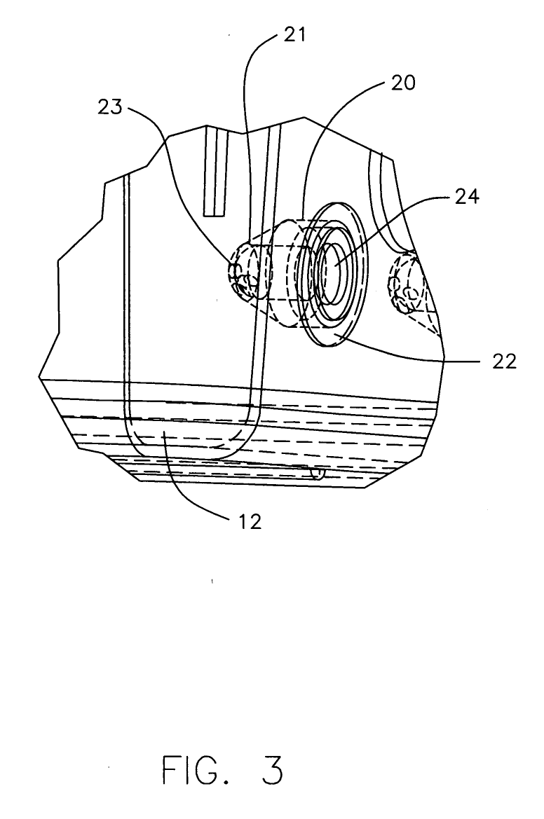

As illustrated in FIG. 3, grommets 20 are typically constructed of brushed stainless steel having a conical nose 21 within base 20 and a smooth flat washer face 22 on the outside. Conical nose 21 has a plurality of small openings 23 for allowing ventilation air to flow into cage 10.

In between conical nose 21 and washer face 22 a polymer seal 24 is provided. Polymer seal 24 is provided with cross hair (x-shaped) slit or other such perforation to allow entry of the ventilation inputs of rack system 100. Seal 24 is preferably formed from a silicone polymer with an added internal lubricant which provides an appropriate seal between the ventilation inputs and the inside of base 12. A sample silicone polymer with an added internal lubricant may be Dow Corning silicone 2-3010 VLBL.

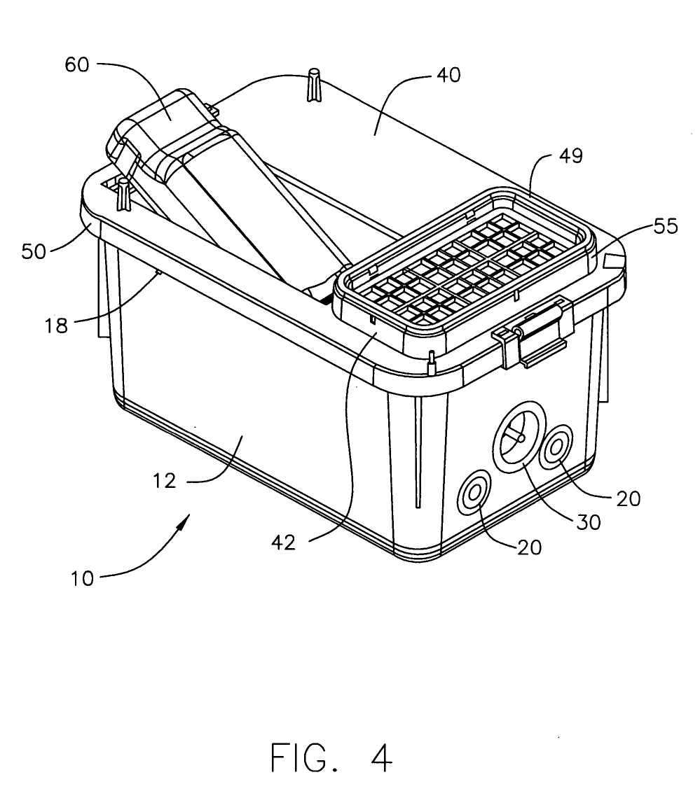

In an alternative embodiment of the present invention, as illustrated in FIG. 4, an automated water system entry port 30 may be included in the back wall of base 12 above grommets 20 in order to connect cage 10 to an automatic water system of ventilated rack system 100 if desired. For the purposes of illustration, some figures include water entry port 30 and others do not, but this in no way intended to convey the necessity of such an element. Any similar cage 10 and system 100, with or without an automated water supply system, is within the contemplation of the present invention.

In one embodiment of the present invention, as illustrated in FIGS. 1 and 2, lid 40 maintains a ventilation exit opening 42 and a water bottle recess 44. Bottle recess 44 may be optionally fitted with a polymer seal 45 for sealing the inside of cage 10 when watering bottle 60 is removed.

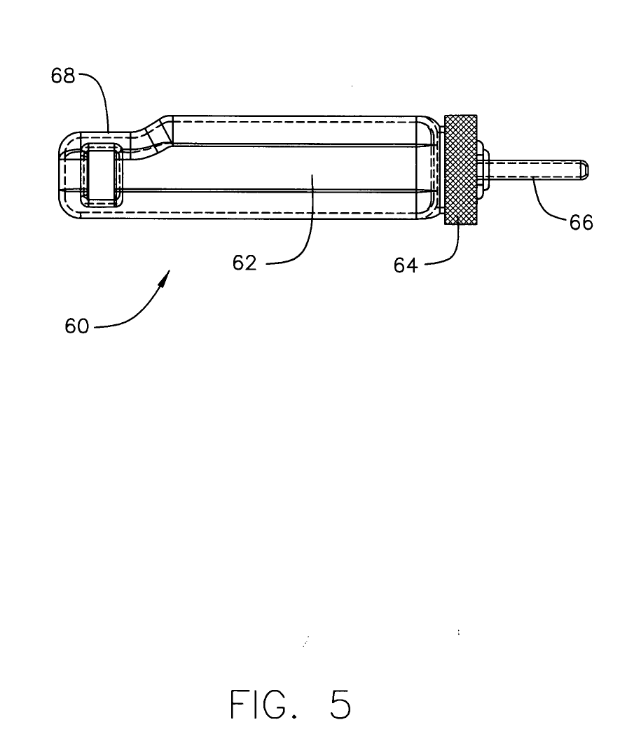

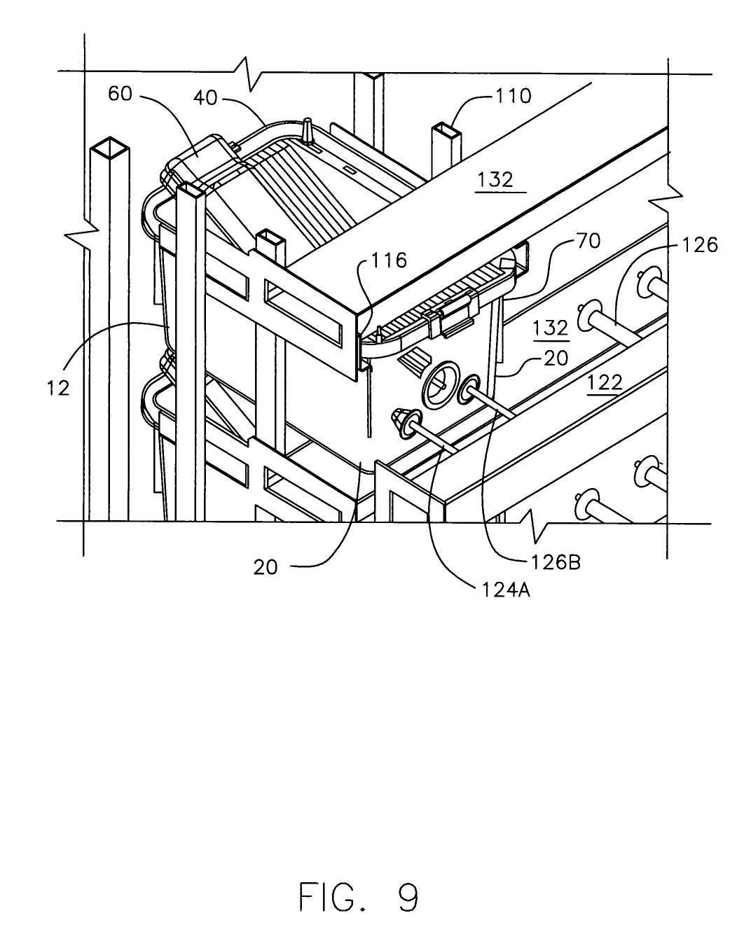

As illustrated in FIG. 5, a cross section of water bottle 60 is shown. Water bottle 60 maintains a main body 62, a cap 64, a water spout 66 and a recessed region 68 opposite cap 64. Water spout 66 is configured to be placed through polymer seal 45 in bottle recess 44 when bottle 60 is placed into cage 10 as shown in FIG. 1. Recessed region 68 allows bottle 60 and cage 10 together to fit into cage bay 114 of system 100, as discussed below and as shown in FIGS. 9-11.

As shown in FIG. 2, ventilation exit opening 42 maintains a base lattice 46 for supporting a piece of filter paper or micro-barrier 47 upon which a mesh plastic cap 48 is placed down, sandwiching paper 47 therebetween. The use of filter paper 47 is optional, but typically used to reduce cross-contamination between cages and to keep contaminates from getting into the ducks of rack system 100. Opening 42 further maintains a gasket ring 55 for holding a polymer gasket 49 therein. Polymer gasket 49 is configured to seal or nearly seal ventilation exit opening 42 with the exhaust ventilation from rack system 100 as discussed in more detail below. Polymer gasket 49 is preferably constructed of a silcone polymer with internal lubricant, which is the same polymer used for polymer seal 24 in grommets 20.

A downward lip 50 is also disposed around the circumference of lid 40 configured to slide over upward flange 16 and lip 14 of base 12. A polymer seal 52, made from EPDM (ethylene propylene diene monomer) or silicone, is disposed around the bottom inside edge of lid 40, inside of lip 50, configured to rest on lip 14 of base 12 so as to form a seal between base 12 and lid 40 when cage 10 is closed. As shown in FIG. 2, a wire bar grid 53 may be inserted between lid 40 and base 12 if desired.

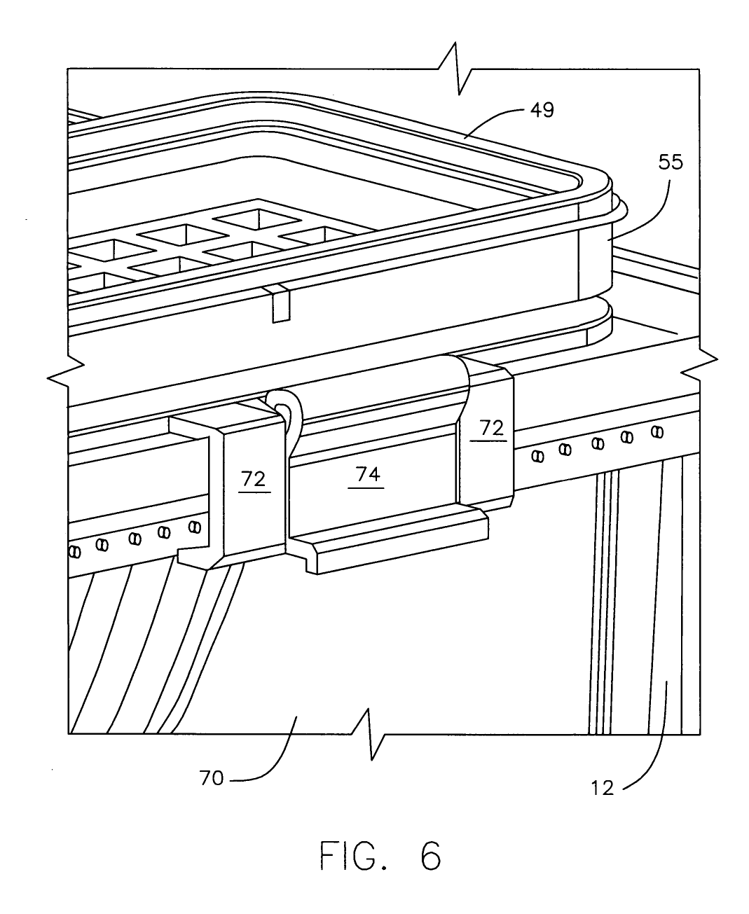

As shown in FIG. 6, lid 40 is attached to base 12 using lid latch 70. Lid latch 70 is configured to be attached to lip 50 of lid 40 via holding clips 72. A central opening latch 74 is configured to extend over lip 50 of lid 40 and underneath of lip 14 of base 12, thus compressing lid 40 down onto base 12. A bending tab 76 is formed on the outside of central opening latch 74 configured to allow a user to easily pry latch 74 backwards with their fingers, away from lip 14 of base 12, so as to release the seal between base 12 and lid 40.

Lid latch 70 provides a simple and easy means to secure lid 40 to base 12. Latch 70 is an improvement over prior art latches in that its singular mold construction and easy opening bending tab 76 formed on the outside of central opening latch 74 allows for a simple and effective latch for sealing lid 40 to base 12.

In one embodiment of the present invention, as illustrated in FIGS. 7a (front) and 7b (back), a ventilated rack system 100 is shown. Rack system 100, preferably maintains a frame 110, optional wheels 112, first and second vertical ventilation input ducts 120a and 120b and first and second vertical ventilation exhaust ducts 130a and 130b. Vertical ventilation input ducts 120 and vertical ventilation exhaust ducts 130 optionally maintain latches or ¼ turn screws or other such fastening devices 129 and 139 respectively in order to allow them to open for easy cleaning.

As shown, frame 110 is shown as a single set frame meaning that all cages 10 open from one side of frame 110. However, it is noted that frame 110 may contain an entire second set of cages 10, each one on opposing sides. In the following descriptions some figures so a single set frame 110 and others show a double sided frame 110. All salient features of the present invention are equally applicable to both designs.

As illustrated in FIGS. 7a and 7b, frame 110 is preferably constructed of stainless steel, however any durable metal or plastic may be used in conjunction with the features of the present invention. Frame 110 is preferably of a uniform shape, such as rectangular, but may be made into any desired shape as per a customer's request, provided it maintains the essential features discussed in detail below.

In one embodiment of the present invention, a plurality of cage bays 114, are disposed on frame 110, each of which is dimensioned to receive a cage 10. In one embodiment of the present invention, each cage bay 114, maintains a pair of cage tracks 116 configured to support the opposing undersides of lip 14 from base 12 of cage 10. This allows for cage 10 to be slid into and out of bays 114 of rack system 100 for cleaning, feeding etc . . .

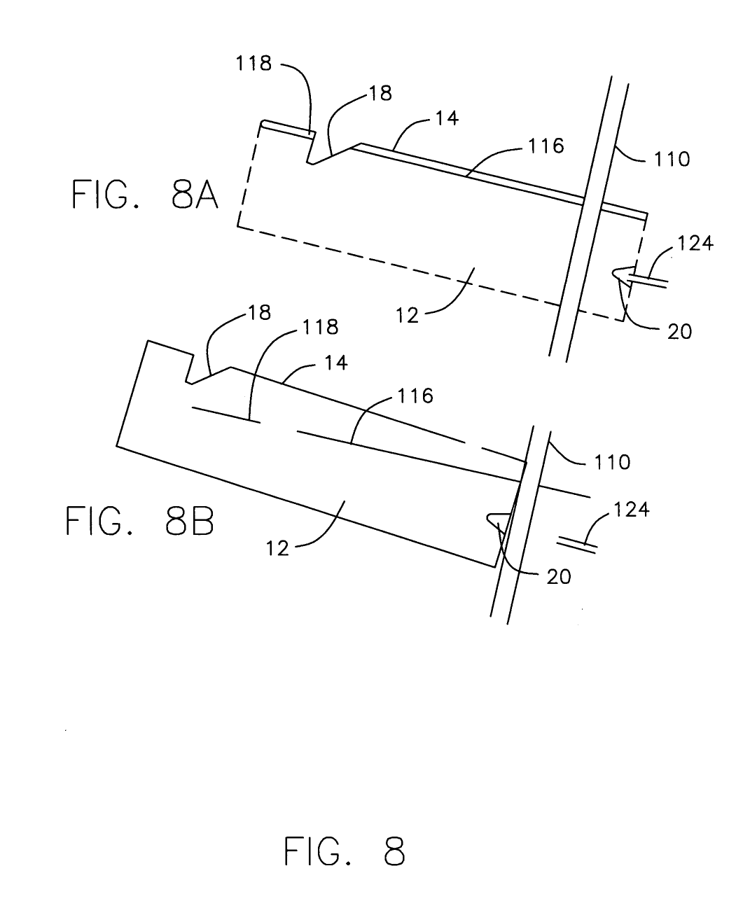

In one embodiment of the present invention, as shown in FIGS. 8a and 8b, a close up of cage tracks 116 is shown, each including a latch opening 118 configured to receive angle latch 18 from the underside of lip 14 of cage 10. In this manner, cages 10 may be slid along tracks 116 into bays 114 until angle latch 18 falls into latch opening 118 at which point cages 10 are locked into cage bays 114 (FIG. 8a). Once inserted, cages 10 may be removed by lifting cage 10 enough such that the bottom of angle latch 18 is fully removed from latch opening 118 so that cages 18 may be pulled forward, out of frame 110 (FIG. 8b). Such an arrangement allows a user to quickly insert, lock and later remove a cage 10 from frame 110 without any complicated latch openings. Furthermore, the simple construction of such a latch is advantageous from a maintenance as well as cleaning perspective as there are no moving parts and the latch 18 is easily cleanable with the rest of base 12. Another advantage is that the latch is easily molded and incorporated in the injection mold for base 12.

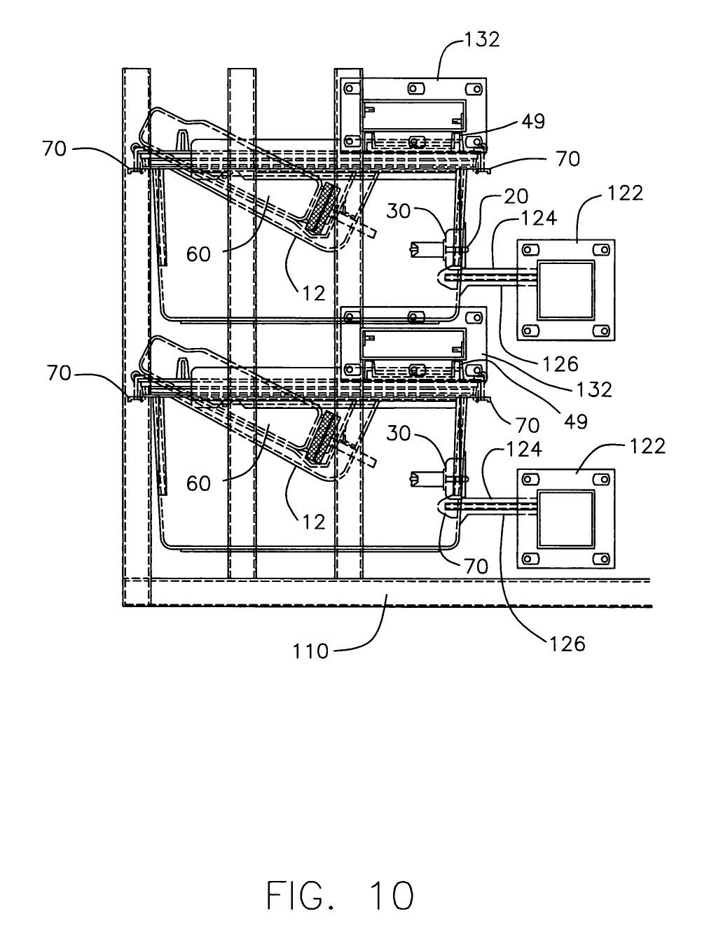

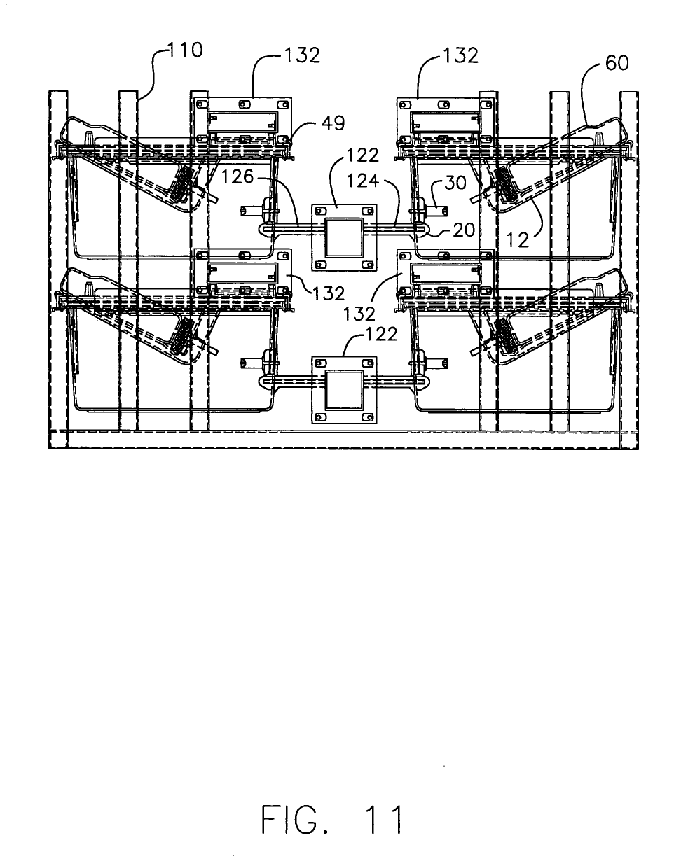

FIGS. 9-11 show various views of cage bays 114 within frame 112. FIG. 9 is a perspective view of cage bays 114, FIG. 10 is across section of the same cage bays 114, and FIG. 11 is a cross section of four cage bays 114 in a double set frame arrangement.

In another embodiment of the present invention, as shown in FIGS. 9-11, frame 110 further maintains a plurality of air input cross-frame channels 122a -122x for allowing input ventilation air from vertical ventilation input ducts 120a and 120b to flow into the center of frame 110. Along each channel 122, pairs of stainless steel ventilation air input tubes 124a and 124b extend perpendicularly away from channel 122 towards the rear end of each cage bay 114. Each ventilation tube 124a and 124b are configured such that when a cage 10 is inserted into a corresponding cage bay 114, air input ventilation tubes 124 insert into the rear of grommets 20, through polymer seal 24.

Optionally, as shown in FIG. 9, ventilation tube seals 126, made from a polymer/rubber material, may be further employed to provide a good seal between ventilation tubes 124 and grommets 20. Such an arrangement allows clean ventilation air to flow from vertical ventilation input ducts 120, through air input cross-frame channels 122, into ventilation tubes 124 and finally through grommets 20 into cages 10.

It is understood that ventilation tubes 124 may extend from air input cross-frame channels 122 in one direction as shown in FIGS. 9 and 10, or out of both sides of air input cross-frame channels 122 in the case of a “double sided” frame 110, as shown in FIG. 11.

In one embodiment of the present invention as illustrated in FIG. 7a clean ventilated air input through he above described arrangements may be provided in any number of conventional arrangements such as through an attached fan 90, such as a squirrel cage fan (filtered or non-filtered), attached on the floor or attached to the top of frame 110 or alternatively through a lab-wide building ventilation system.

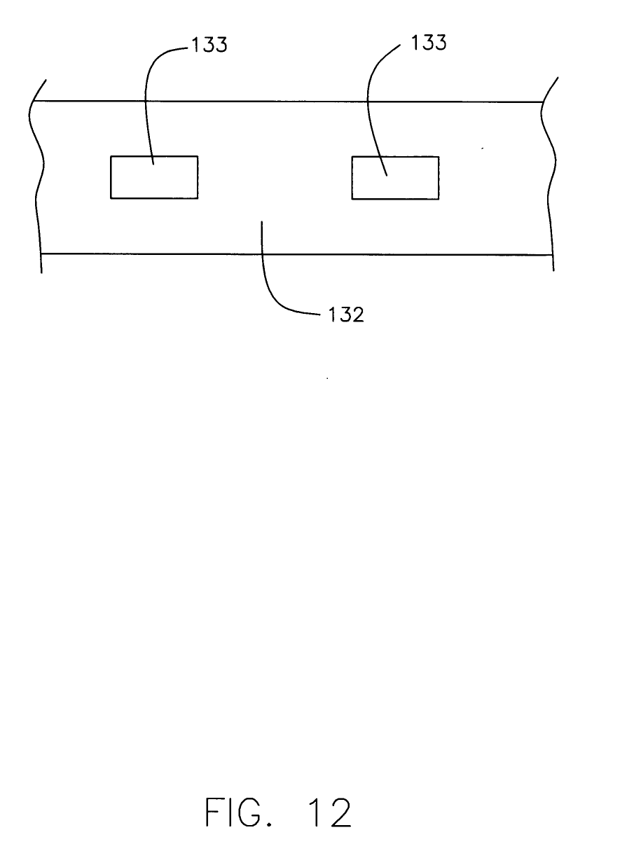

In one embodiment of the present invention as illustrated in FIGS. 9-11, frame 110 further maintains a plurality of air exhaust cross-frame channels 132a -132x for allowing exhaust ventilation air from vertical ventilation exhaust ducts 130a and 130b to flow from the center of frame 110. Along each channel 132, a series of exhaust openings 133 are disposed along the bottom surface, one above the rear end of cage bays 114. FIG. 12 shows an underside of channel 132 with rectangular exhaust openings 133. Each exhaust opening 133 is configured such that when a cage 10 is inserted into a corresponding cage bay 114, ventilation exit opening 42 and corresponding polymer gasket 49 is brought into mating relationship, allowing the ventilation air being input through grommets 20 to escape out of the top of lid 40.

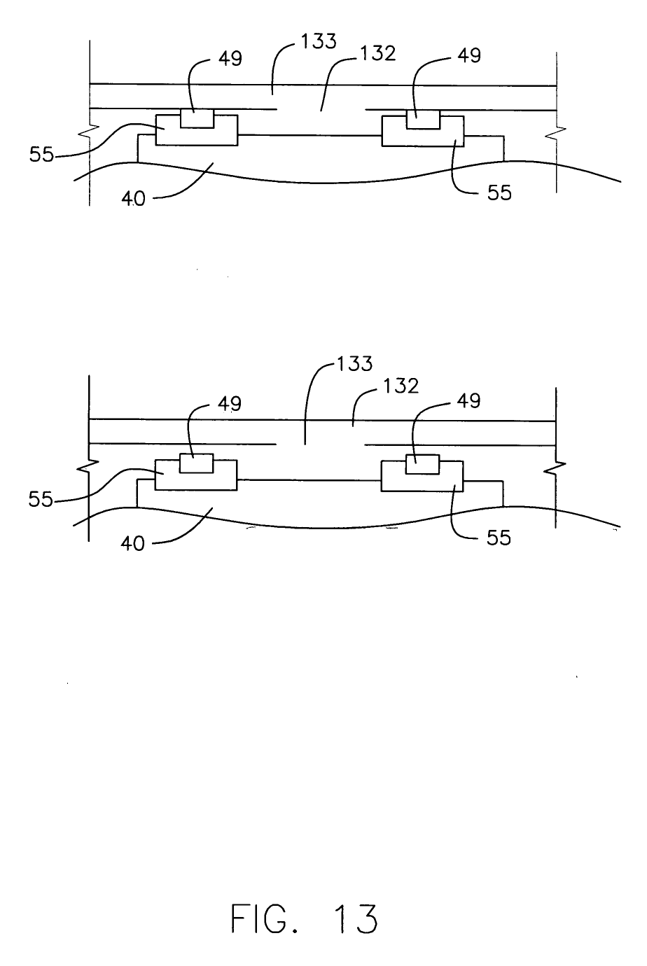

In a first embodiment, although a polymer gasket 49 is shown, this gasket 49 may either directly and entirely seal against exhaust openings 133 as shown in close up FIG. 13a, or allow a limited gap between air exhaust cross-frame channels 132, as shown in close up FIG. 13b. In either arrangement, depending on the construction of cage bays 114, because of the material used for gasket 49 slides relatively easily along the underside of channels 132, yet it may generate enough of a seal to cause air to be channeled into exhaust openings 133, whether sealed tightly or not.

It is understood that air exhaust cross-frame channels 132 may extend across frame 110 either along a single side or across both sides in the case of a “double sided” frame 110 as shown in FIG. 11.

As with air input, exhaust air, expelled into vertical ventilation exhaust ducts 130 via exhaust openings 133, may be further suctioned by way of a vacuum pump 92 attached to ducts 130, either from the floor or on top of frame 110, or, alternatively through a lab-wide building exhaust/vacuum ventilation system. Such an arrangement prevents escaping air from lid 40 from cross contaminating into other adjacent or near-adjacent cages 10 in frame 110.

According to the present invention a number of distinct advantage over the prior art are known.

The above described arrangement provides a number of advantages over the prior art regarding the ventilation air flow. In prior art cages a single entry point for the incoming air flow leads to an increased air flow over the animals in the cage, contributing to certain problems such as hypothermia. By distributing the two grommets 20 across the back wall of base 12, the airflow into base 12 is distributed more evenly, and thus the reduced air speed prevents a strong draft from blowing over the animals.

Additionally, the positioning of grommets 20 across the back bottom of base 12 and the exhaust opening 42 in lid 40 being disposed at the top, above the grommet 20 entry point first causes even air flow over the animal bedding in the base. This helps keep the animal bedding dry. Secondly, this arrangement causes the incoming ventilation air to flow first along the entire bottom of base 12 and them upward and back to opening 42 for complete air recycling within cage 10. This is a significant improvement over prior art arrangements where the ventilation air is both input and exhausted from the top of the cage resulting in insufficient circulation or other prior art designs that simply allow the air to flow out from around the perimeter of the lid.

Also, with regard to ventilation air flow, the use of two vertical ventilation input ducts 120, one on either side of each air input cross-frame channels 122 makes sure that air flow through each of the cage bays 114 is even. In prior art systems with only one main vertical input duct, cages closer to the duct maybe overly ventilated causing overly intense drafts over the animals whereas cages away from the duct are under ventilated.

Another advantage over prior art ventilated cages is the use of the silicone polymer with added internal lubricant for use as grommet seal 24 and exhaust gasket 49 in lid 40. Typically, prior art cages employ a rubber or other high friction polymer for seals or a flap with clearance. However, the silicone with lubricant used in the present invention has a low friction against adjacent surfaces. When used in grommets 20 it allows for easy insertion and removal of air input tubes 124 without overly wearing on the seal, while simultaneously adequately sealing the ventilation air from cage base 12. Likewise, the use of this silicon polymer for gasket 49 alleviates the problem of gasket 49 slipping out of gasket ring 55 as cage 10 is placed into bay 114 against the underside of channel 132 to match with rectangular exhaust openings 133.

In addition to the above advantages, in the arrangement where gasket 49 is not tightly sealed against the underside of channel 132, opening 42 in lid 40 is large enough such that in the event that the ventilation system fails (e.g. power outage) there is still enough air flow that the animals to survive. In prior art arrangements, when lids are either too tightly sealed to the exhaust system or if the exhaust opening is too small, animals may suffocate more quickly in the event of a ventilation power failure.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1) A ventilated rack system comprising:
a frame having a plurality of cage bays, each for supporting an animal cage;
at least two first and second vertical ventilation input ducts, one on either side of said frame; and
at least one air input cross-frame channel configured to connect said first vertical ventilation input duct on one side of said frame to said second vertical ventilation input duct on the opposite side of said frame, wherein said air input cross-frame channel is configured to dispense ventilation air into said cages in said plurality of cage bays.

2) The ventilation rack system as claimed in claim 1, wherein said frame maintains a plurality of air input cross-frame channels, each connected at one end to said first vertical ventilation input duct and at a second end to said second vertical ventilation input duct.

3) The ventilation rack system of claim 1, wherein said frame further maintains first and second vertical ventilation exhaust ducts, one on either side of said frame.

4) The ventilation rack system of claim 3, wherein said frame further maintains at least one air exhaust cross-frame channel, between said first and second vertical ventilation exhaust ducts configured to remove exhaust air from said cages in said plurality of cage bays.

5) The ventilation rack as claimed in claim 4, wherein said frame maintains a plurality of air exhaust cross-frame channels, each connected at one end to said first vertical ventilation exhaust duct and at a second end to said second vertical ventilation exhaust duct.

6) The ventilation rack as claimed in claim 1, wherein said plurality of cage bays, each maintains cage tracks having latch openings for receiving said cages.

7) The ventilation rack as claimed in claim 6, wherein each of said cages maintains a circumferential lip with an angle latch, said angle latch configured to fit into said latch openings for securing said cages in said cage bays.

8) The ventilation rack as claimed in claim 3, wherein said vertical ventilation input ducts and said vertical ventilation exhaust ducts maintain latches for opening said ducts for cleaning.

9) A ventilated rack system comprising:
a frame having a plurality of cage bays, each for supporting an animal cage, said cage having at least two grommets in a back wall for allowing ventilation air input;
at least one air input cross-frame channel; and
at least two ventilation air input tubes, extending perpendicularly from said air input cross-frame channel into the back end of one of said cage bays, wherein said ventilation air input tubes are configured to enter into the rear of said grommets in said cage to input ventilation air into said cages.

10) The ventilated rack system as claimed in claim 9, wherein said frame maintains a plurality of air input cross-frame channels, and a plurality of ventilation air input tubes, such that for each cage in said frame there are two ventilation air input tubes, one for each grommet in said cage.

11) The ventilated rack system as claimed in claim 9, wherein said grommets in said cage are located in the lower half of the cage in said back wall of said cage.

12) The ventilated rack system as claimed in claim 9, wherein said ventilation air input tubes each maintain ventilation tubes seals.

13) The ventilated rack system as claimed in claim 9, wherein said grommets maintain a polymer seal configured to allow said ventilation air input tubes to be inserted into said grommet.

14) The ventilated rack system as claimed in claim 13, wherein said polymer seal is made from a silicone polymer with an internal lubricant.

15) A ventilated rack system comprising:
a frame having a plurality of cage bays, each for supporting an animal cage, said cage having grommets in a back wall for allowing ventilation air input;
at least one air input cross-frame channel;
ventilation air input tubes extending perpendicularly from said air input cross-frame channel into the back end of said cage bays for inputting ventilation air into said cages via said grommets;
a least one air exhaust cross-frame channel configured to collect air from said cages and remove it away from said frame; and
a lid on top of said cage, said lid having a gasket ring with a polymer gasket therein, said polymer gasket configured to interface with an exhaust opening in said air exhaust cross-frame channel wherein said polymer gasket is made from a silicone polymer with an internal lubricant, for allowing said gasket to both seal against said air exhaust cross-frame channel while simultaneously allowing said polymer seal to slide easily along the underside of air exhaust cross-frame channel without pulling out of said gasket ring.

16) The ventilated rack system as claimed in claim 15, wherein said lid further supports a filter paper in the interface between said cage and said exhaust opening in said air exhaust cross-frame channel.

17) The ventilated rack system as claimed in claim 15, wherein said lid is connected to said cage via lid latch, said lid latch constructed with a central opening latch for clipping said lid to a lip of said cage.
